(19) United States
(12) Patent Application Publication
(10) Pub. No.: US 2015/0178774 A1
(43) Pub. Date: Jun. 25, 2015

(54) METHOD AND SYSTEM FOR TARGETING ADVERTISEMENTS ON DISPLAY DEVICES BASED ON USER'S NFC BASED TRANSACTION AND WEB BROWSING ACTIVITIES

(71) Applicant: SAMSUNG ELECTRONICS CO., LTD., Suwon-si (KR)

(72) Inventors: Abhishek VIJAY, Noida (IN); Chirag PATEL, Noida (IN); Jamal HAIDAR, Noida (IN)

(73) Assignee: SAMSUNG ELECTRONICS CO., LTD., Suwon-si (KR)

(21) Appl. No.: 14/566,855

(22) Filed: Dec. 11, 2014

(30) Foreign Application Priority Data
Dec. 20, 2013 (IN) 6002/CHE/2013

(51) Int. Cl. G06Q 30/02

(52) U.S. Cl. CPC G06Q 30/0255; G06Q 30/0267

(57) ABSTRACT

A method and system for targeting advertisements based on users NFC based transaction activities and web browsing activities is provided. The method includes tracking at least one transaction performed by a user on the display device. The method includes analyzing one or more web pages corresponding to the transactions. Further, the method includes collecting data with reference to the transaction. Furthermore, the method includes targeting advertisements on the display device based on the data collected.

### CROSS-REFERENCE TO RELATED APPLICATION

This application claims priority from India Patent Application No. 6002/CHE/2013, filed on Dec. 20, 2013 in the India Patent Office, the disclosure of which is incorporated herein by reference in its entirety.

### BACKGROUND

1. Field

The present invention relates to the field of Near Field Communication (NFC), and more specifically to the field of targeting advertisements on display devices based on users NFC based transaction and web browsing activities corresponding to the transaction.

2. Description of the Related Art

Advertisements are increasingly being used as a significant source of revenue. Advertisements are often provided in the form of banners, textual advertisements, pop-ups, or the like. With expanding global marketplace, marketers are continually looking out for new and effective ways to reach consumers. Various methods for targeting advertisements exists including, site based, keyword based, contextual, demographic based and many more.

Oftentimes, the subject matter of the advertisements targeted does not align with current preferences or interests of the consumers. Thus, lack of accuracy results in missed opportunities for providing appropriate information to the users.

In light of the foregoing discussion there is a need for an efficient method and system that targets advertisements based on users transaction and browsing activities.

### SUMMARY

Embodiments of the present disclosure described herein provide a method and system for targeting advertisements based on users NFC based transaction and web browsing activities corresponding to the transaction.

An example of a method for targeting advertisements based on users NFC based transaction and web browsing activities corresponding to the transaction. The method includes tracking a transaction performed by a user on the display device. Further, the method includes analyzing one or more web pages corresponding to a transaction. Furthermore, the method includes collecting data with reference to the transaction. Moreover, the method includes targeting advertisements on the display device based on the data collected.

An example of a system for targeting advertisements based on users NFC based transaction and browsing activities includes a NFC enabled mobile device and a non-NFC enabled device. Further, the system includes a NFC enabled Remocon and a display device to receive user credentials from the Remocon. Furthermore, the system includes a processor coupled to the display device and operable to track a transaction performed by a user on the display device and analyze one or more web pages corresponding to a transaction. Further, the processor collects data with reference to the transaction and targeted advertisements on the display device.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

The accompanying figure, similar reference numerals may refer to identical or functionally similar elements. These reference numerals are used in the detailed description to illustrate various embodiments and to explain various aspects and advantages of the present disclosure.

FIG. 1 is an illustration of communication channels to send data from a NFC mobile device to a display device, in accordance with one embodiment;

FIG. 2 illustrates interaction of a display device with a distant server, in accordance with one embodiment;

FIG. 3 illustrates a display device showing the method recommending advertisements to a user, in accordance with one embodiment;

FIG. 4 is a block diagram of a display device, in accordance with one embodiment;

FIG. 5 illustrates an NFC application in a display device, in accordance with one embodiment;

FIG. 6 illustrates NFC core components in an NFC application, in accordance with one embodiment;

FIG. 7 illustrates an overall flow of the method of operation of the proposed invention;

FIG. 8 illustrates a flowchart showing a method to recommend advertisements in display device based on NFC based transaction and browsing activities, in accordance with one embodiment;

FIG. 9 illustrates a flowchart showing a method to download keyword list from server, in accordance with one embodiment; and

FIG. 10 illustrates a flowchart showing a method to display advertisements on a display device, in accordance with one embodiment.

### DETAILED DESCRIPTION OF EXEMPLARY EMBODIMENTS

Embodiments of the present disclosure described herein provide a method and system for targeting advertisements on display devices based on users NFC based transaction and web browsing activities corresponding to the transaction.

NFC is a technology existing on a chip or a device and operates between two or more devices. The devices are located within a near proximity to each other and can transfer any form of information. Basically, NFC is activated by bringing any two NFC devices together. The User Mobile Device can also be replaced with unpowered NFC chip referred to as “tags”. The display device describes integration of the Internet into television sets to provide an interactive experience for users. Further, display devices provide features like Web browsing, video-on-demand and video streaming, social networking, Internet radio, games and so on.

The following detailed description is intended to provide example implementations to one of ordinary skill in the art, and is not intended to limit the invention to the explicit disclosure, as one or ordinary skill in the art will understand that variations can be substituted that are within the scope of the invention as described.

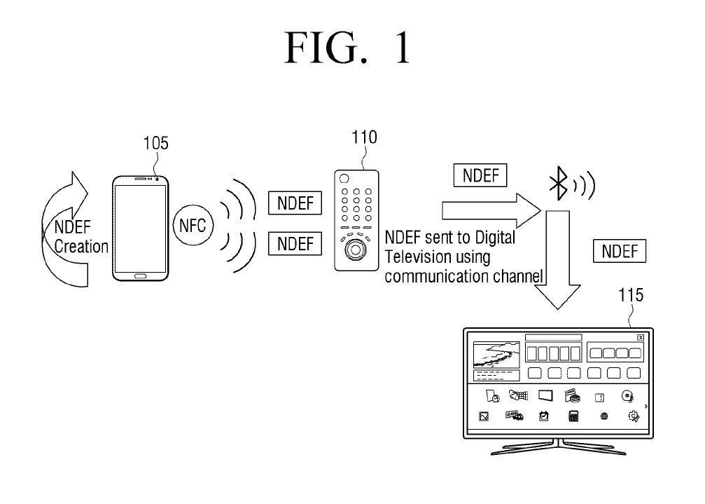

FIG. 1 is an illustration of communication channels used to send data from a NFC mobile device to a display device, in accordance with one embodiment.

A user mobile device 105 includes an NFC reader to read data from a plurality of contactless cards. The contactless cards hold electronic information that can be read from a distance with special equipment that uses radio waves. Subsequently, the user mobile device 105 an itself emulate as a NFC tag which can then be tapped on a Remocon 110 to pass the data. Alternatively, the user can tap the contactless cards directly on the Remocon 110 to pass the data. Further, Transaction data is encapsulated in packets referred to as NFC Data Exchange Format (NDEF) packets in a user mobile device 105. The encapsulation process is commonly referred to as NDEF creation. Consequently, the NDEF packets are sent to the Remocon 110 when the user mobile device 105 is tapped on the Remocon 110.

The Remocon 110 holds NFC capabilities of reading the NDEF packets through a NFC reader. The data read by the NFC reader includes data which is essential for online payments and web data. Subsequently, the NDEF packets are passed from the Remocon 110 to a display device 115, through a communication channel for example, Bluetooth. The display device 115 parses and extracts data from the NDEF packets for further processing.

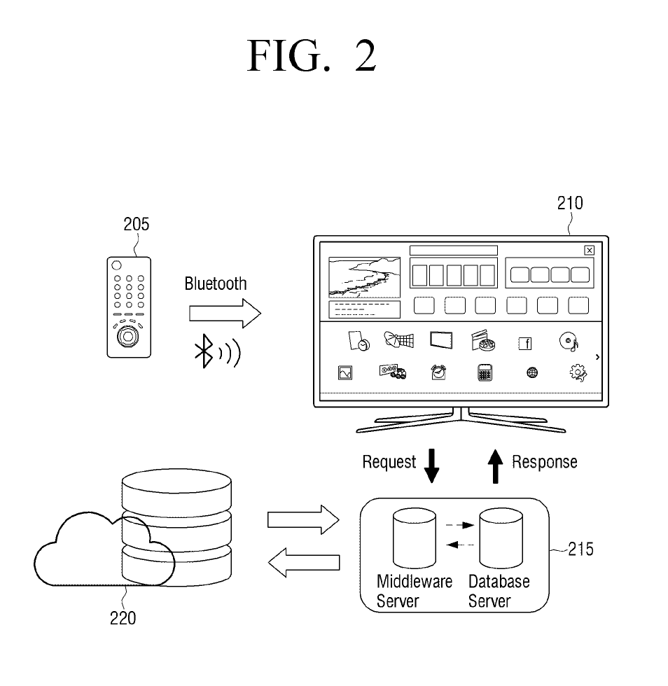

FIG. 2 illustrates interaction of a display device with a distant server, in accordance with one embodiment.

A Remocon 205 sends NDEF packets to a display device 210 using a communication channel, for example Bluetooth. However, other communication channel can also be used. Further, the display device 210 is connected to a distant server 215. The distant server (also referred to as a remote server) 215 includes a middleware server and a database server that communicates with each other. A cloud service database 220 connects to the database and stores all keywords which are generated by a keyword extraction engine.

Information related to transaction activities is stored in memory. Further web pages corresponding to the transaction is analyzed and keywords from the web pages or result of the analysis are stored in the memory. The stored information can be shared on a network server and can be sent to third parties (including TV broadcasters and ad agencies). Consider, a same party (such as Samsung) having application running on TV and remocon. In such a case, the party can have a network server of their own and provide advertisements on televisions. The advertisements can be provided in various forms such as pop ups or as a window on the television or by various other means on the television.

Moreover, the cloud service database 220 is shared with various content publishing organizations. As the user begins to browse, the cloud service database 220 is queried and subsequently, the user preferences are identified. Based on the results obtained from querying, specific products, advertisements and offers are provided to the user on the display device 210.

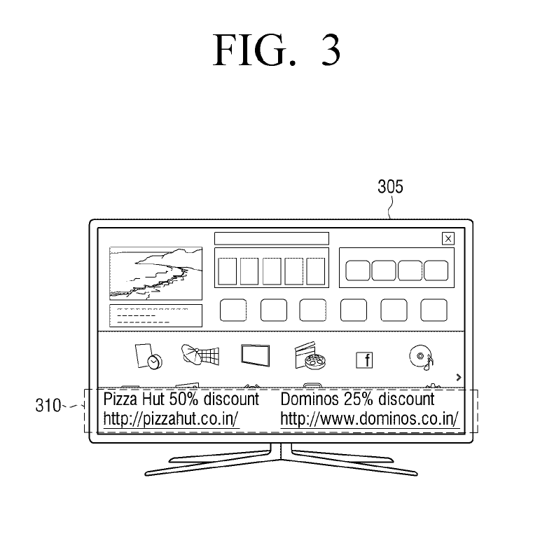

FIG. 3 illustrates a display device showing the method of targeting advertisements to a user, in accordance with one embodiment.

The display device is a Smart television 305 that integrates television and the Internet to provide an interactive experience for users. Based on previous NFC based transaction history and web browsing history, one or more recommendations are shown to the user on the Smart television screen.

Consider a scenario where a user performs a successful transaction on the display device. Subsequent web pages are analyzed to identify that the transaction for a particular amount for a specific product or service is done, for a particular vendor, for example Pizza Hut. The transaction data such as pizza type, pizza size and total cost or similar information is collected and saved in the display device. The transaction activity data and above browsing data are shared with the vendor. Consequently, advertisements are targeted based on the transaction data and browsing data. Consequently, advertisements related to Pizza Hut discounts are displayed to the user on the display device. Similarly, multiple more relevant offers can also be displayed to the user according to past purchases, for example “Pizza Hut discount” and “Dominos Pizza discount” for a specific pizza.

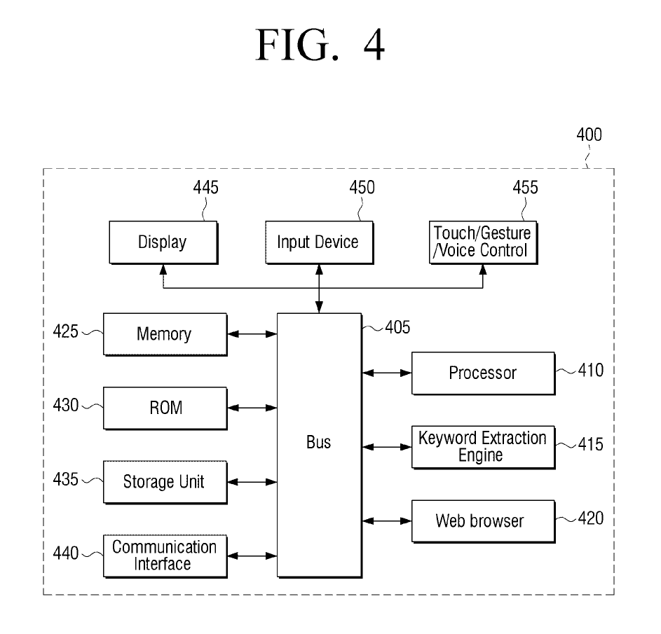

FIG. 4 is a block diagram of a display device, in accordance with one embodiment.

The display device 400 includes a bus 405 or other communication mechanism for communicating information. The display device 400 includes a processor 410, a keyword extraction engine 415 and a web browser 420 coupled with the bus 405. The processor 410 includes an NFC application that is used to extract data from NDEF packets received from a display device remocon. The processor 410 can include an integrated electronic circuit for processing and controlling functionalities of the display device 400. Further, the keyword extraction engine 415 is used to extract keywords from web pages during or corresponding to a transaction activity. The web browser 420 is used to make any payments using NFC. The display device 400 also includes a memory 425, such as a random access memory (RAM) or other dynamic storage device, coupled to the bus 405 for storing information which can be used by the processor 410. The memory 425 can be used for storing any temporary information required. The display device 400 further includes a read only memory (ROM) 430 or other static storage device coupled to the bus 405 for storing static information for the command processor module 410. A storage unit 435, such as a magnetic disk or optical disk, is provided and coupled to the bus 405 for storing information.

Various embodiments are related to the use of the display device 400 for implementing the techniques described herein. In one embodiment, the techniques are performed by the processor 410 using information included in the memory 425. The information can be read into the memory 425 from another machine-readable medium, such as the storage unit 435. The instructions are stored in the memory 425.

The term “machine-readable medium” as used herein refers to any medium that participates in providing data that causes a machine to operate in a specific fashion. In an embodiment implemented using the display device 400, various machine-readable medium are involved, for example, in providing information to the processor 410. The machine-readable medium can be a storage media. Storage media includes both non-volatile media and volatile media. Non-volatile media includes, for example, optical or magnetic disks, such as the storage unit 435. Volatile media includes dynamic memory, such as the memory 425. All such media must be tangible to enable the information carried by the media to be detected by a physical mechanism that reads the information into a machine.

Common forms of machine-readable medium include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge. In another embodiment, the machine-readable medium can be a transmission media including coaxial cables, copper wire and fiber optics, including the wires that include the bus 405. Transmission media can also take the form of acoustic or light waves, such as those generated during radio-wave and infra-red data communications. The display device 400 also includes a communication interface 440 coupled to the bus 405.

The display device 400 can be coupled via the bus 405 to a display 450, such as but not limited to a liquid crystal display (LCD), a large format display (LFD), a light emitting diode (LED) display or plasma, for displaying television programming, menus, information, advertising and other informative messages. An input device 450 is coupled to the bus 405 for communicating an input to the processor 410. The input device 450 can be included in the display device 400. Another type of user input device is a Touch, Gesture, or Voice control 455, such as a swipe, pattern, and voice recognition or cursor direction keys for communicating the input to the processor 410 and for controlling cursor movement on the display 445. The input device 450 can also be included in the display 445, for example a touch screen.

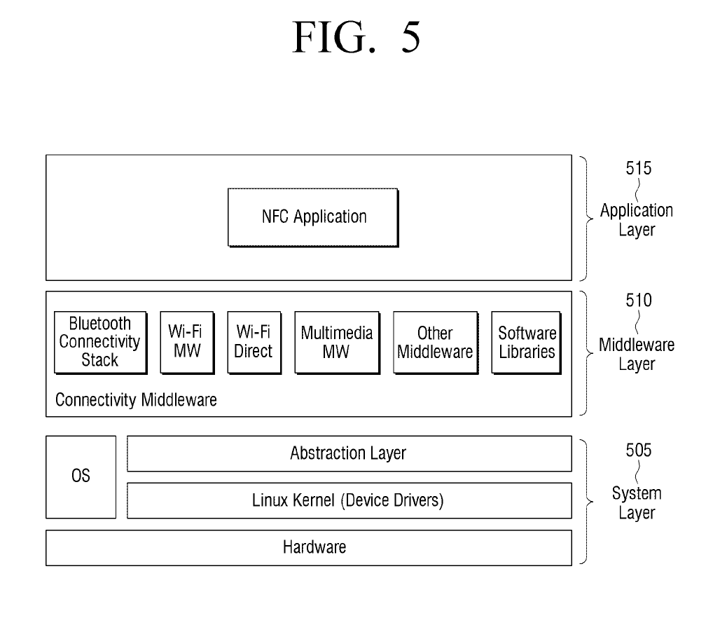

FIG. 5 illustrates an NFC application in display device, in accordance with one embodiment.

The architecture diagram of a Display Device includes three basic layers namely a system layer 505, a middleware layer 510 and an application layer 515. The system layer 505 is the lowest most layer and includes Hardware, Linux Kernel (Device Drivers), Abstraction Layer and an Operating System (OS). The middleware layer 510 includes Connectivity Middleware, Multimedia MW, other Middleware and Software Libraries. The Connectivity Middleware further includes Bluetooth Connectivity Stack, Wi-Fi MW and Wi-Fi Direct. Further, an NFC application is installed in the application layer 515. The NFC application is responsible for extracting data from the NDEF packets that are received from a Remocon. The extracted data is then used to complete a transaction. The NFC application is also responsible to display the necessary User Interface (UI) on the display device.

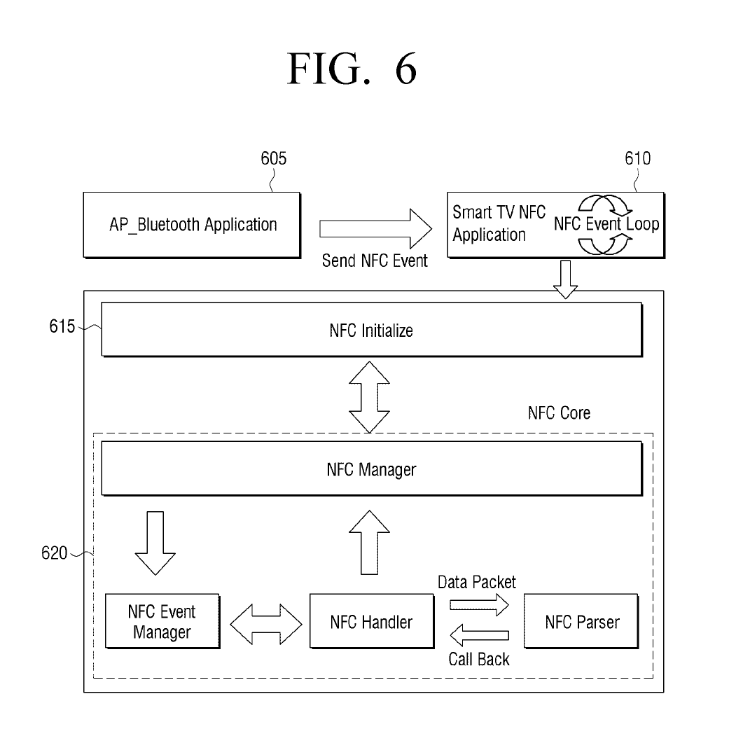

FIG. 6 illustrates NFC core components in an NFC application, in accordance with one embodiment.

A Bluetooth Application 605 in a display device receives data from a Remocon. The display device NFC Application 610 captures an event that is initialized by the Bluetooth Application 605. The event signifies that data has been received from the Remocon. At this instance, the display device NFC Application 610 initializes a NFC framework 615 and acquires an instance of a NFC Manger 620. The NFC Manager 620 passes the data received to a NFC Event Manager 625 and then later to the NFC Handler 630. Subsequently, the NFC Handler 630 forwards the data to a NFC Parser 635. The NFC Parser 635 extracts the data from the NDEF packets. Consequently, the NFC Event Manager 625 notifies the NFC Application that is data is available for further action.

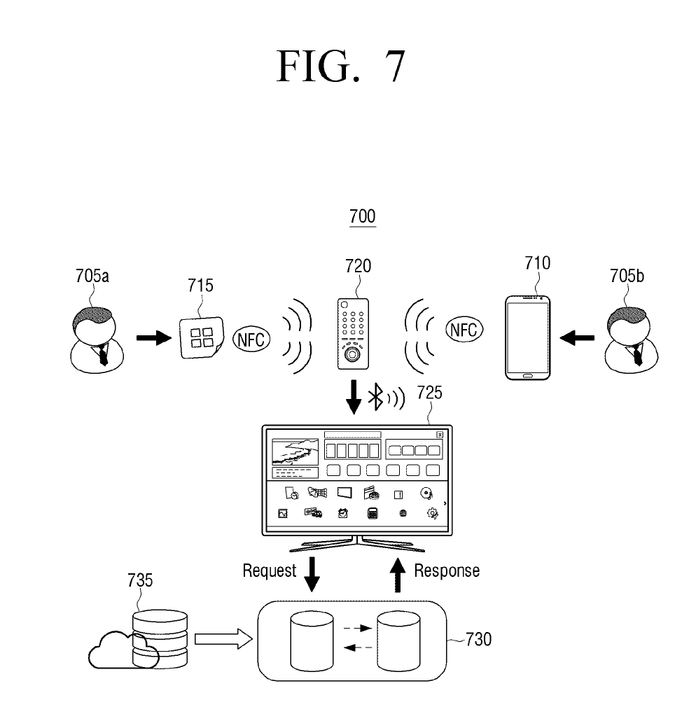

FIG. 7 is a block diagram of an environment, in accordance with which various embodiments can be implemented. The environment 700 includes one or more users, for example a user 705a and a user 705b. Typically, the user owns a NFC enabled mobile device 710. In some scenarios, the user own NFC tags 715. The user taps the NFC enabled mobile device 710 on a NFC enabled Remocon 720. Alternatively, NFC tags 715 are also tapped on the NFC enabled Remocon 720. At this instance of tapping, user credential data (login id & password) is passed to the NFC enabled Remocon 720. This data is encapsulated in NDEF packets. Further, the NFC enabled Remocon 720 sends the NDEF packets to a display device 725 through Bluetooth.

Further, NFC enabled mobile device or NFC tag can have multiple user credential data corresponding to banks or other online payment service providers. At the time of tapping, only specific user credential data which is required for the payment on display device is passed to remocon and further to the display device.

The display device 725 sends a request to a server 730. Subsequently, the server 730 responds to the display device 725. Generally, the server 730 includes a Middleware server and a Database server. The Middleware server hosts a HTTP server. The display device 725 makes HTTP requests such as, GET, PUSH and STOP for showing content on the display device 725. The server 730 is connected to a cloud service 735. The cloud service 735 includes a database of purchase activity details extracted from the users NFC based transaction and web browsing activities corresponding to the transaction

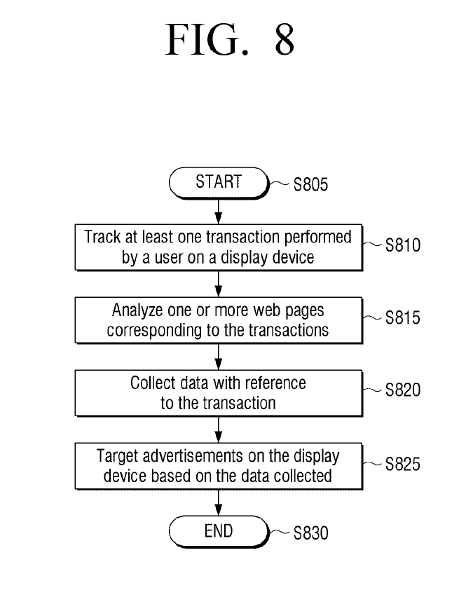

FIG. 8 illustrates a flowchart showing a method to target advertisements in based on users NFC based transaction and web browsing activities corresponding to the transaction, in accordance with one embodiment. The flowchart begins at step S805.

At step S810, a transaction is tracked which is performed by a user on a display device.

The display device is a television with integrated Internet capabilities to allow one or more users to utilize apps and browse the Internet directly on the television. Accordingly, the display device needs to be connected to the Internet.

Often, the user performs transactions on the display device to buy a particular product or service. A transaction occurs when the user taps a NFC tag or a NFC enabled mobile device on a remocon. Such transactions are tracked by an application installed on the display device. For example, the user performs a transaction on the display device to buy pizzas from Pizza Hut.

Further, the transactions are analyzed to identify a successful transaction and an unsuccessful transaction.

In some embodiments, the Display Device includes an NFC application which connects to a server when the Display Device is switched “ON”. Subsequently, the Display Device parses any NDEF data that is received from a Display Device remocon using a communication channel. In some embodiments, the server can be a cloud server. The cloud service meets the need of users registered with the cloud service. Examples of cloud services include, but is not limited to, online data storage and backup solutions, web-based e-mail services, document collaboration services and database processing. Similarly, cloud storage is a cloud service that enables various clients to access a storage space over the Internet. The cloud service is shared with a plurality of content publishing organizations.

In some embodiments, the user can also choose to enable and disable advertisements feature on the Display Device. The NFC transaction and browsing activities is monitored and tracked only when the user provides his agreement.

At step S815, one or more web pages are analyzed corresponding to a transaction.

The user browses one or more web pages to select a desired product or service for a transaction. The transaction can be a successful transaction or an unsuccessful transaction. A successful transaction results from the user buying the product or service. In scenarios where the user falls short of buying a product or service, the transaction is referred to as an unsuccessful transaction. Consequently, a certain number of web pages (for example four to five web pages) prior to the transaction is analyzed. In other words, browsing related web page data corresponding to the transaction is analyzed.

A specific number of web pages, for example five to ten web pages, are stored in the display device. Further, only in case of transaction activities, the web pages are analyzed.

During a transaction activity, when a user taps a NFC tag and NFC enabled mobile on a remocon, result of the transaction activity such as successful or unsuccessful transaction can be decided based on analysis of subsequent web pages on the display device.

Further, the web pages are analyzed corresponding to a transaction activity, to identify if a particular product or service is tried to be purchased by the user.

Further, user credentials data (user's login ID and password) is also passed to the display device.

At first, the remocon receives the NFC transaction data in the form of NDEF packets from a NFC enabled mobile device. A user of the NFC enabled mobile device passes contents that are browsed on the mobile device browser to the Display Device. At this instance, the user is asked to tap the NFC enabled mobile device on the remocon. Information from the NFC enabled mobile device is transferred to the remocon. This information is user credential data. Alternatively, the NFC details can also be obtained from a NFC based device, such as a tag or payment card. The tag is typically an unpowered NFC chip also referred to as an NFC tag. NFC tags are small programmed information areas that can be embedded on posters, billboard advertisements and next to products in retail stores. Here again, the user is asked to tap the NFC tag on the remocon. Eventually, the remocon receives NDEF data and sends it to the NFC application in the Display Device.

An event is fired on the Display Device to check if any NDEF packets are received.

At step S820, data is collected with reference to the transaction.

Typically, transaction activity data and browsing related web page data corresponding to a transaction are collectively grouped and stored in the display device. For multiple transactions, such data is stored in the display device. The complete data can be passed instantaneously or periodically to the distant server.

On receiving the NDEF packets, the NFC application in the Display Device identifies specific keywords or analyzes product or service for which transaction has been made. In particular, Keywords are words that distinguish the user's interest, for example, “Pizza”, “Artificial Jewellery” and “Movie”. These keywords are used to identify user's preferences.

A keyword extraction engine is used to extract keywords from the web pages corresponding to the transaction. Individual services are required to store the keywords on a server and to fetch the keywords from the server to show recommendations.

Subsequent to collecting the data, the data is forwarded to a server. The data is also shared with a third party. However, only transaction activity data and web browsing activity data is shared with the third party. The user credentials data is not shared with the third party. The third party can be a distant server or a content publishing organization.

At step S825, advertisements are targeted on the Display Device based on the data collected. Based on the web browsing activities and the query results (previous purchase history), appropriate advertisements are displayed to the user on the display device by the server. Specific products and offers are also recommended to the user. For example, for the keyword “Pizza” extracted from the NFC transaction data, offers from “Dominos Pizza” and “Pizza Hut” is displayed to the user. Further, advertisements are provided to the display device corresponding to a successful transaction.

The flowchart ends at step 830.

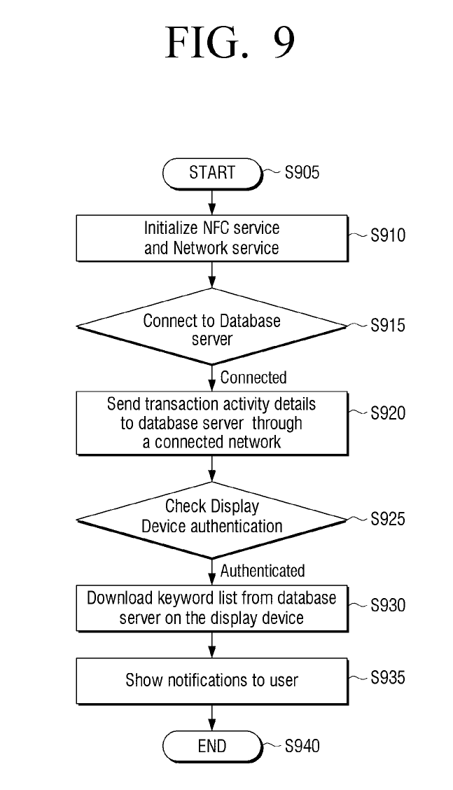

FIG. 9 illustrates a flowchart showing a method to download keyword list from a server, in accordance with one embodiment. The flow chart begins at step 1105.

At step S910, NFC service and Network service is initialized. The NFC service is initialized on the Display Device when it is powered on.

At step S915, the Display Device is connected to the database server.

At step S920, transaction activity details are sent to the database server through a connected network.

At step S925, the display device is checked for authenticity. The display device can receive user data from the database server only if it is authenticated.

At step S930, a keyword list is downloaded from a server on the display device. The list provides all the keywords that the user has used during web browsing or purchasing.

At step S935, notifications are shown to the user.

The flowchart ends at step 960.

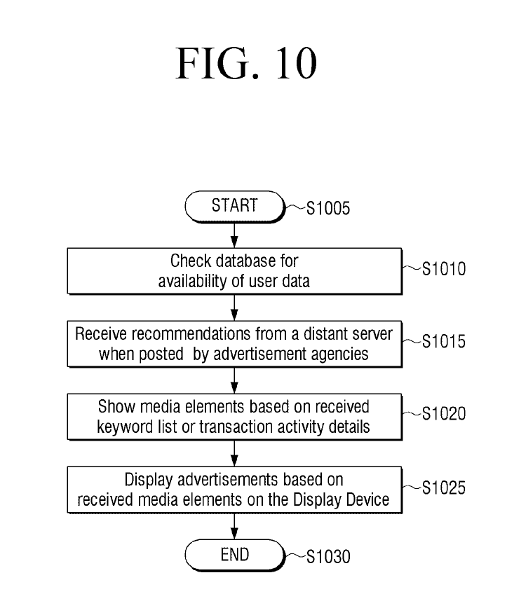

FIG. 10 illustrates a flowchart showing a method to display advertisements on a display device, in accordance with one embodiment. The flowchart begins at step S1005.

At step S1010, a database is checked for availability of user data. The database resides in a distant server and stores a list of keywords.

At step 1015, recommendations are received from the distant server when posted by advertisement agencies.

At step S1020, media elements are shown based on the received keywords list or transaction activity details. Characteristically, the media elements are in the form of text, Hyper Text Markup Language (HTML), pictures, audio and video.

At step S1025, advertisements are displayed based on received media elements on the display device.

The flowchart ends at step 1035.

Advantageously, the embodiments specified in the present disclosure provide transaction details in seamless method using NFC. The proposed invention is efficient as the user is recommended with advertisements, promos and offers based on browsing activities and transaction details at all times. Further, since browsing activities is also considered, in scenarios where transactions have not been initiated, advertisements are still recommended to the user. The proposed invention eliminates security risks as no transaction data is stored at the server side.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

Although all of elements constituting exemplary embodiments are combined into one or are combined to operate, the present general concept is not limited to the exemplary embodiments. In other words, all of the elements may be selectively combined into one or more to operate within the scope. Also, all of the elements may be realized one independent hardware, but some or all of the elements may be selectively combined to be realized as a computer program having a program module performing functions of some or all of the combined elements in one hardware or a plurality of pieces of hardware. Codes and segments constituting the computer program may be easily inferred by those skilled in the art. The computer program may be stored on a non-transitory computer-readable medium to be read and executed by a computer.

The non-transitory computer-readable medium refers to a medium which does not store data for a short time such as a register, a cache memory, a memory, or the like but semi-permanently stores data and is readable by a device. In detail, the above-described applications or programs may be stored and provided on a non-transitory computer readable medium such as a CD, a DVD, a hard disk, a blue-ray disk, a universal serial bus (USB), a memory card, a ROM, or the like.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of targeting advertisements based on users NFC based transaction and browsing activities, the method comprising:
tracking at least one transaction performed by a user on the display device;
analyzing one or more web pages corresponding to the transactions;
collecting data with reference to the transaction; and
targeting advertisements on the display device based on the data collected.

2. The method as claimed in claim 1 and further comprising:
forwarding the collected data to a server; and
displaying advertisements based on the collected data, by the server, on the display device.

3. The method as claimed in claim 1, wherein the transaction occurs when the user taps one of a NFC tag and a NFC enabled mobile device on a remocon.

4. The method as claimed in claim 1, wherein tracking the transaction comprises:
analyzing the transaction to identify a successful transaction and an unsuccessful transaction; and
providing advertisements corresponding to the successful transaction.

5. The method as claimed in claim 1 wherein tracking the transaction is performed in response to the user enabling an advertisement feature on the display device.

6. The method as claimed in claim 1, wherein the transactions are tracked by an application installed on the display device.

7. The method as claimed in claim 1 and further comprising:
sharing the data from a third party to a broadcaster.

8. The method as claimed in claim 7, wherein the third party is one of a distant server and a content publishing organization.

9. A system for targeting advertisements based on users NFC based transaction activities and browsing activities, the system comprising:
a NFC enabled mobile device;
a non-NFC enabled device;
a NFC enabled Remocon;
a display device to receive user credentials data from the NFC enabled Remocon; and
a processor coupled to the display device and operable to:
racking at least a transaction performed by a user on the display device;
analyzing one or more web pages corresponding to the transactions;
collecting data with reference to the transaction; and
targeting advertisements on the display device based on the data collected.

10. The system as claimed in claim 9 wherein the non-NFC enabled device is one of NFC tags and payment cards.

11. The system as claimed in claim 9 and further comprising:
a third party to receive the data from the display device, wherein the data comprises of user transaction activity data and web browsing activity data.

12. The system as claimed in claim 11, wherein the third party is one of a distant server and a content publishing organization.
